(19) United States
(12) Patent Application Publication
(10) Pub. No.: US 2020/0009905 A1
(43) Pub. Date: Jan. 9, 2020

(54) VEHICLE WHEEL

(71) Applicant: HONDA MOTOR CO., LTD., Tokyo (JP)

(72) Inventors: Youichi KAMIYAMA, Wako-shi (JP); Toshinobu SAITO, Wako-shi (JP); Yusuke OSAWA, Wako-shi (JP)

(21) Appl. No.: 16/460,725

(22) Filed: Jul. 2, 2019

(30) Foreign Application Priority Data
Jul. 9, 2018 (JP) 2018-129705

(51) Int. Cl. B60B 21/12; G10K 11/172

(52) U.S. Cl. CPC B60B 21/12; G10K 11/172; B60B 2360/30; B60B 2360/10; B60B 2900/133

(57) ABSTRACT

A vehicle wheel includes: a wheel having a rim; a sub-air chamber member serving as a Helmholtz resonator; and a support member integrated with the sub-air chamber member and joined to the rim. The sub-air chamber member is made of a synthetic resin. The support member is made of a metal.

### CROSS-REFERENCE TO RELATED APPLICATIONS

The present application claims priority under 35 U.S.C. § 119 to Japanese Patent Application No. 2018-129705, filed Jul. 9, 2018, the contents of which are hereby incorporated by reference in their entirety.

### BACKGROUND OF THE INVENTION

### 1. Field of the Invention

The present invention relates to a vehicle wheel.

### 2. Description of the Related Art

There has been known a wheel including a well portion and a Helmholtz resonator (sub-air chamber member) that is attached to the well portion and cancels air column resonance noises in a tire air chamber (e.g., see Japanese Patent No. 4551422). The sub-air chamber member of the wheel is a resin molded product, and has two sides which are opposite to each other in a wheel width direction and on each of which an elastically deformable plate-shaped edge portion is formed.

This sub-air chamber member is attached to the well portion by the edge portions being respectively fitted into groove portions formed on rising walls of the well portion.

### SUMMARY OF THE INVENTION

In general, a sub-air chamber member can be attached to a wheel by various methods such as adhering, welding, or fastening with bolts and the like, in addition to the fitting method described above. The attachment of the sub-air chamber member to the wheel has to be firm enough to withstand a great centrifugal force that can be applied to the sub-air chamber member during wheel rotation.

However, as sub-air chamber members of the conventional vehicle wheels (e.g., see Japanese Patent No. 4551422) are made of a synthetic resin, the adhesion force of the sub-air chamber members to a wheel made of a metal is often insufficient. In addition, a sub-air chamber member made of a synthetic resin cannot be practically welded to the metal wheel like a metal sub-air chamber member can be, and fastening members of the sub-air chamber member may fail to provide sufficient support strength of for supporting the sub-air chamber member. For this reason, for conventional vehicle wheels including a sub-air chamber member made of a synthetic resin, there has been a demand for providing various modes of attaching the sub-air chamber member to the vehicle wheel.

An object of the present invention is to provide a vehicle wheel including a sub-air chamber member made of a synthetic resin such that the sub-air chamber member can be attached to the vehicle wheel in various modes.

A vehicle wheel according to the present invention includes: a wheel having a rim; a sub-air chamber member serving as a Helmholtz resonator; and a support member integrated with the sub-air chamber member and joined to the rim. The sub-air chamber member is made of a synthetic resin. The support member is made of a metal.

According to the present invention, it is possible to provide a vehicle wheel including a sub-air chamber member made of a synthetic resin such that the sub-air chamber member can be attached to the vehicle wheel in various modes.

### BRIEF DESCRIPTION OF THE DRAWINGS

FIG. 1 is a perspective view of a vehicle wheel according to an embodiment of the present invention.

FIG. 2 is an overall perspective view of a sub-air chamber member.

FIG. 3 is a cross-sectional view taken along line in FIG. 1.

FIG. 4 is an overall perspective view of a sub-air chamber member according to a modification.

FIG. 5 is a cross-sectional view of a vehicle wheel according to another embodiment that includes the sub-air chamber member shown in FIG. 4.

### DETAILED DESCRIPTION OF THE EMBODIMENTS

Next, a vehicle wheel according to embodiments of the present invention is described in detail with reference to the drawings as needed. In the referenced drawings, “X” indicates a wheel circumferential direction, “Y” indicates a wheel width direction, and “Z” indicates a wheel radial direction.

The vehicle wheel of this embodiment includes a sub-air chamber member made of a synthetic resin, and the sub-air chamber member is joined to a rim of the vehicle wheel via metal support members integrated with the sub-air chamber member.

### Overall Configuration of Vehicle Wheel

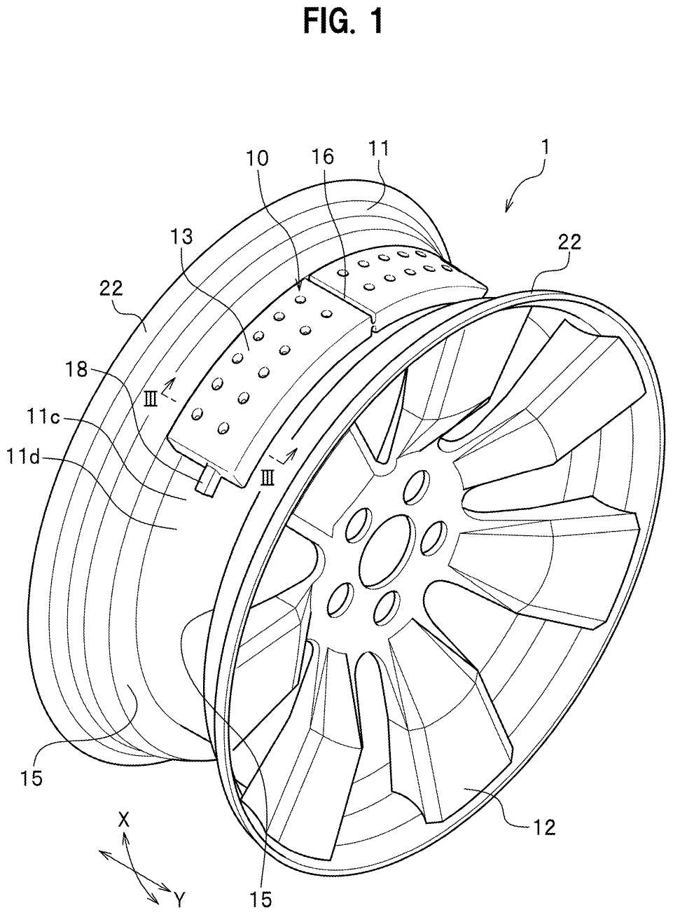

FIG. 1 is a perspective view of a vehicle wheel 1 according to an embodiment of the present invention.

As shown in FIG. 1, the vehicle wheel 1 according to the present embodiment has a rim 11 and a sub-air chamber member 10 attached to the rim 11 to serve as a Helmholtz resonator. The rim 11 is made of a light metal such as an aluminum alloy or a magnesium alloy. The sub-air chamber member 10 is made of a synthetic resin. In FIG. 1, the reference sign 12 indicates a disc for coupling the rim 11 to a hub not shown.

The rim 11 has two end portions that are opposite to each other in the wheel width direction Y, at each of which a bead seat not shown is formed, and has a well portion 11c recessed toward a wheel axis in the wheel radial direction between the bead seats. A bottom surface of this recess defines an outer circumferential surface 11d of the well portion 11c, which has a substantially constant diameter about the wheel axis along the wheel width direction Y.

The rim 11 includes a pair of rising portions 15 that rise toward rim flanges 22 of the rim 11 respectively from two end portions of the outer circumferential surface 11d of the well portion 11c that are located opposite each other in the wheel width direction Y.

In FIG. 1, the reference sign 10 indicates the sub-air chamber member serving as the Helmholtz resonator.

### Sub-Air Chamber Member

Next, a description will be given of the sub-air chamber member 10.

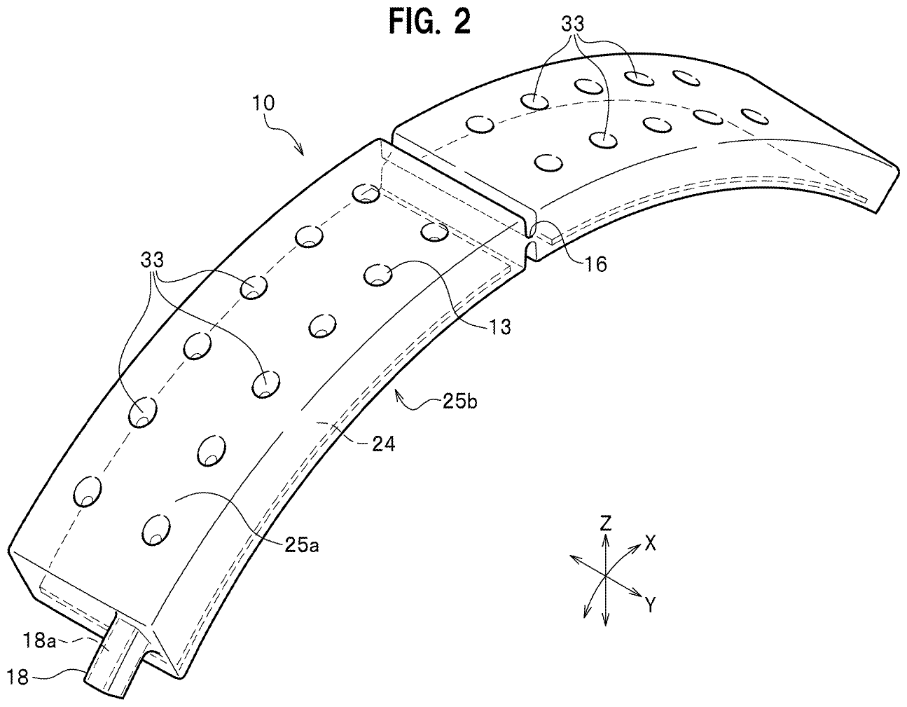

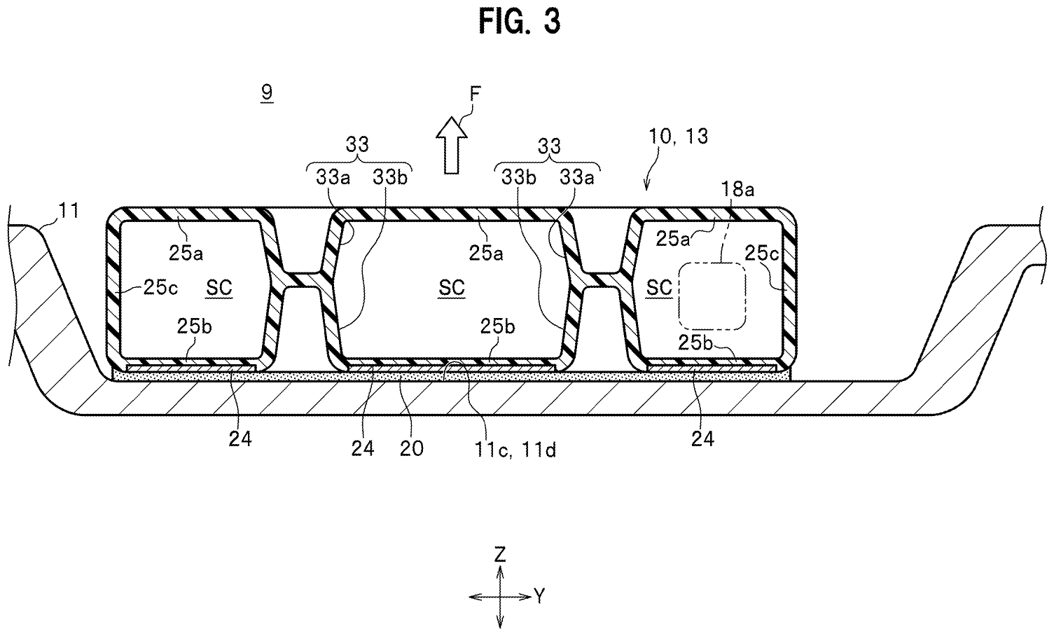

FIG. 2 is an overall perspective view of the sub-air chamber member 10. FIG. 3 is a cross-sectional view taken along line in FIG. 1. Note that the reference sign 24 in FIG. 2 indicates metal plates serving as support members, which are shown by hidden lines (dotted lines).

As shown in FIG. 2, the sub-air chamber member 10 is a member which is elongated in one direction and includes a main body portion 13 and tube bodies 18. This sub-air chamber member 10 of the embodiment is, for example, a resin molded product.

This sub-air chamber member 10 has a partition wall 16 extending in the wheel width direction Y in the middle of the main body portion 13, and has a shape symmetrical about the partition wall 16 in the wheel circumferential direction X.

The main body portion 13 is longitudinally curved. In other words, the main body portion 13 extends in the wheel circumferential direction X when the sub-air chamber member 10 is attached to the well portion 11c (see FIG. 1).

The main body portion 13 has a hollow space inside. This hollow space (not shown) constitutes a sub-air chamber SC (see FIG. 3) described later. This hollow space is partitioned by the partition wall 16 in the wheel circumferential direction X into two halves.

As shown in FIG. 3, the main body portion 13 has a substantially rectangular shape elongated in the wheel width direction Y in a cross-sectional view orthogonal to the longitudinal direction (wheel circumferential direction X shown in FIG. 2) of the main body portion 13.

Specifically, the main body portion 13 includes a bottom plate 25b that is in contact with the outer circumferential surface 11d of the well portion 11c and extends in the wheel width direction Y, an upper plate 25a that is located opposite the bottom plate 25b above the outer circumferential surface 11d, and a pair of side plates 25c which respectively rise from two ends of the bottom plate 25b that are located opposite each other in the wheel width direction Y and which are joined to the upper plate 25a.

The bottom plate 25b is a plate body that extends substantially flat in the wheel width direction Y. This bottom plate 25b is curved in the wheel circumferential direction X (see FIG. 1) with substantially the same curvature as the curvature of the outer circumferential surface 11d.

The upper plate 25a is curved in the wheel circumferential direction X (see FIG. 1) with a predetermined curvature in such a way as to face the bottom plate 25b while keeping a predetermined distance therefrom.

The side plates 25c rise outward in the wheel radial direction Z from the bottom plate 25b substantially perpendicularly to the outer circumferential surface 11d of the well portion 11c.

These upper plate 25a, bottom plate 25b, and side plates 25c define the sub-air chamber SC inside the main body portion 13 in a manner that surrounds the sub-air chamber SC.

As shown in FIG. 2, the main body portion 13 includes multiple bridges 33 aligned at regular intervals in the wheel circumferential direction X. These bridges 33 are aligned in two rows in the wheel width direction Y.

As shown in FIG. 3, each bridge 33 has an upper joining portion 33a and a lower joining portion 33b which are joined to each other at a substantially center position between the upper plate 25a and the bottom plate 25b.

The upper joining portion 33a is a portion of the upper plate 25a that is partially recessed toward the bottom plate 25b. The lower joining portion 33b is a portion of the bottom plate 25b that is partially recessed toward the upper plate 25a.

Each of the bridges 33 has a circular cylindrical shape and partially connects between the upper plate 25a and the bottom plate 25b. Each bridge 33 has openings each having a circular shape in plan view at portions of the main body portion 13 that is opposite to each other in the wheel radial direction Z.

Next, a description will be given of the tube body 18 (see FIG. 1).

As shown in FIG. 1, each tube body 18 is formed on a wheel width direction Y one side of a wheel circumferential direction X end of the main body portion 13 so as to project from the main body portion 13 in the wheel circumferential direction X.

As described, the sub-air chamber member 10 of the present embodiment has a shape symmetrical about the partition wall 16 in the wheel circumferential direction X. Thus, although only one tube body 18 is shown in FIG. 1, the tube bodies 18 of the present embodiment are formed on the main body portion 13 at two end portions thereof located symmetrically opposite to each other in the longitudinal direction (wheel circumferential direction X) so as to form a pair. Incidentally, the pair of tube bodies 18 in the present embodiment are arranged at positions spaced at substantially 90-degree intervals about the wheel axis.

As shown in FIG. 2, a communication hole 18a is formed inside the tube body 18.

As shown in FIG. 3, the communication hole 18a allows communication between the sub-air chamber SC formed inside the main body portion 13 and a tire air chamber 9 that is formed above the well portion 11c between the well portion 11c and a tire (not shown).

### Metal Plate (Support Member)

Next, a description will be given of the metal plates 24 (see FIG. 2) serving as support members.

As indicated by the hidden lines (dotted lines) in FIG. 2, the metal plates 24 of this embodiment are arranged on a lower surface (on an inner side in the wheel radial direction Z) of the main body portion 13.

Specifically, as shown in FIG. 3, the metal plates 24 are arranged on the main body portion 13 to form a surface facing the outer circumferential surface 11d of the well portion 11c.

Each of the metal plates 24 is, for example, a metal plate integrated with the bottom plate 25b of the main body portion 13. More specifically, the metal plate 24 is a plate that is arranged in a predetermined mold to be insert molded in a process of molding the sub-air chamber member 10 in the die.

The metal plate 24 of this embodiment is a plate made of the same material as that of the rim 11. However, the metal plate 24 is not limited thereto.

### Sub-Air Chamber Member Attachment Structure

Next, a description will be given of a structure for attaching the sub-air chamber member 10 (see FIG. 1) to the rim 11 (see FIG. 1).

As shown in FIG. 3, the bottom plate 25b of the main body portion of the sub-air chamber member 10 is bonded to the outer circumferential surface 11d of the well portion 11c with an adhesive 20.

Well-known adhesives for adhering metals can be used as the adhesive 20. Examples of the adhesive 20 include an epoxy adhesive. However, the adhesive 20 is not limited thereto. The hardening process of the adhesive 20 is not limited to a particular type of process. However, chemical-reaction based processes are preferred among others.

The adhesive 20 can be applied on either the sub-air chamber member 10 or the rim 11. Alternatively, the adhesive 20 may be applied on both the sub-air chamber member 10 and the rim 11.

Examples of the method of applying the adhesive 20 include bar coating, roll coating, spray coating, brushing, hot-melt coating, and the like. However, the application method is not limited to the foregoing.

With the structure of the vehicle wheel 1 of this embodiment, as the metal plates 24 serving as support members are integrated with the sub-air chamber member 10, it is possible to use metal-to-metal adhesive bonding to join the sub-air chamber member 10 to the rim 11. According to the structure of the vehicle wheel 1, the adhesion force of the sub-air chamber member 10 to the rim 11 becomes dramatically greater than that in a case of adhering the sub-air chamber member 10 made of the synthetic resin directly to the rim 11.

According to the vehicle wheel 1 of this embodiment, it is possible to further improve the mechanical strength of the sub-air chamber member 10 by integrating the metal plates 24 with the sub-air chamber member 10.

As the metal plates 24 of the vehicle wheel 1 according to this embodiment is insert molded in the sub-air chamber member 10, the metal plates 24 are easily integrated with the sub-air chamber member 10.

As describe later, the sub-air chamber member 10 integrated with a metal support member can be joined to the rim 11 by fastening with bolts and the like.

Although an embodiment of the present invention has been described above, the present invention is not limited to the embodiment described above and can be carried out in various modes.

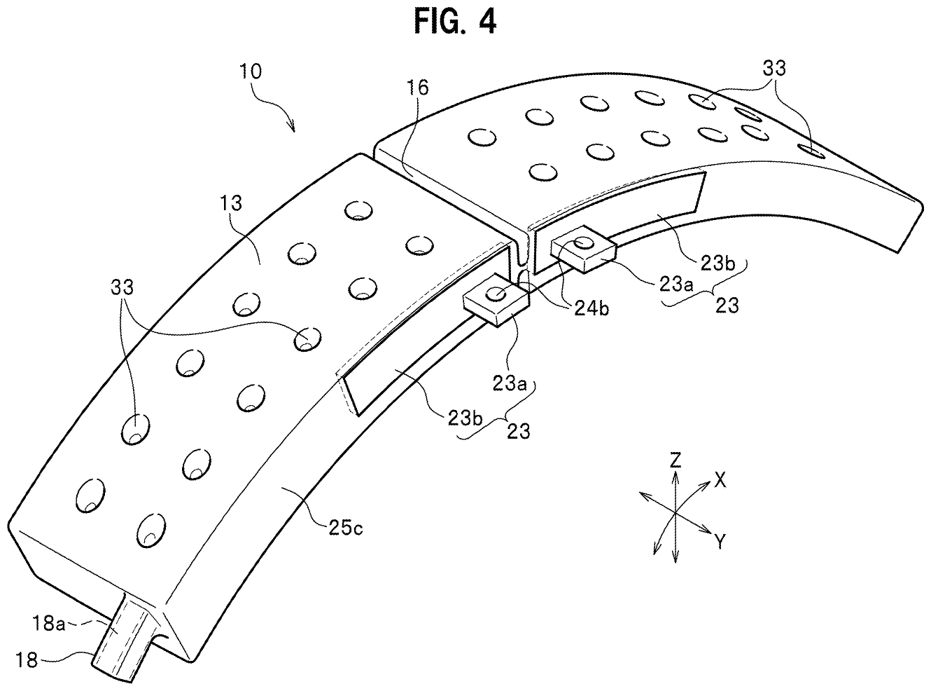

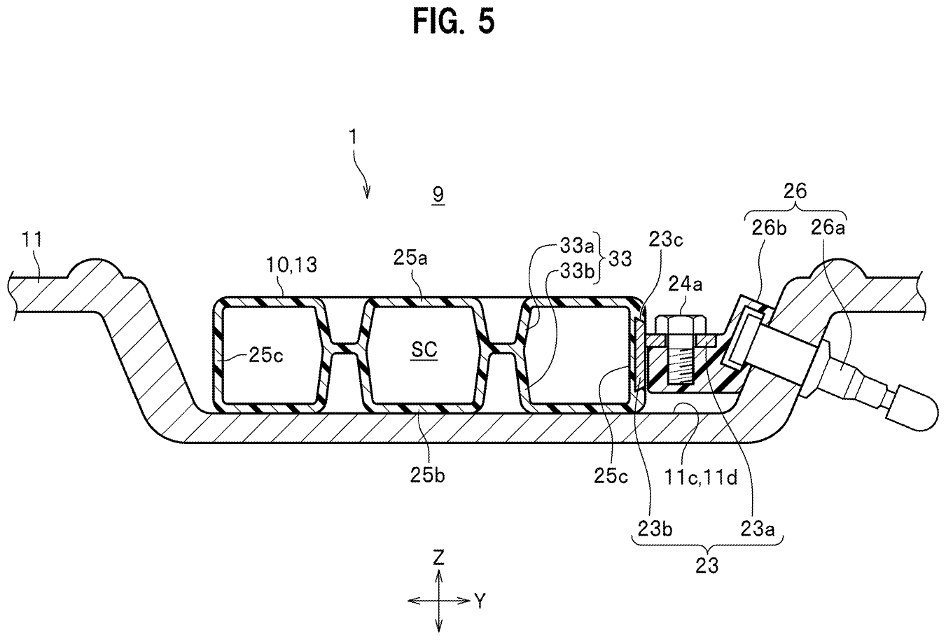

FIG. 4 is an overall perspective view of a sub-air chamber member 10 according to a modification. FIG. 5 is a cross-sectional view of a vehicle wheel 1 according to another embodiment that includes the sub-air chamber member 10 shown in FIG. 4, taken along the wheel width direction Y. Note that, in this vehicle wheel 1, the same constituents as those of the vehicle wheel 1 according to the above embodiment are denoted by the same reference signs and their detailed descriptions will be omitted.

As shown in FIG. 4, the main body portion 13 of the sub-air chamber member 10 of this modification of the embodiment includes a pair of metal brackets 23 serving as support members.

The pair of brackets 23 (support members) are disposed symmetrically about the partition wall 16 in the wheel circumferential direction X.

The brackets 23 each include a fastening portion 23a and a base bottom portion 23b.

The base bottom portion 23b is formed of an elongated plate. This base bottom portion 23b is joined to one of the side plates 25c of the main body portion 13 that is located closer to the disc 12 (see FIG. 1) by being insert molded therein. Specifically, the base bottom portion 23b is joined to the main body portion 13 by being partially embedded in the side plate 25c in such a way that an outer surface of the base bottom portion 23b is exposed to the outside of the main body portion 13.

As shown in FIG. 5, a tapered portion 23c is formed on an outer periphery edge of the base bottom portion 23b (along the entire periphery thereof). This tapered portion 23c has a cross section with a diverging shape that diverges in a direction from the outside of the main body portion 13 toward the sub-air chamber SC. The base bottom portion 23b partially embedded in the side plate 25c is firmly joined thereto due to this diverging shape of the tapered portion 23c.

As shown in FIG. 4, the fastening portion 23a is located close to the partition wall 16, and is a plate body having a substantially rectangular shape in plan view and protruding from the base bottom portion 23b in the wheel width direction Y. This fastening portion 23a is joined to the base bottom portion 23b in such a way that the plate surface faces in the wheel radial direction Z.

The fastening portion 23a has an insertion hole 24b which penetrates the fastening portion 23a in the wheel radial direction Z and in which a bolt 24a (see FIG. 5) is to be inserted.

In FIG. 4, a reference sign 18 indicates the tube bodies, and a reference sign 33 indicates the bridges.

As shown in FIG. 5, the fastening portion 23a of the bracket 23 is fastened to an air valve assembly 26.

The air valve assembly 26 of this embodiment includes an air valve main body 26a fixed on the rim 11 and a holding portion 26b that is assembled with the air valve main body 26a and holds the sub-air chamber member 10.

The holding portion 26b has a threaded hole formed thereon, with which the bolt 24a is thread-engaged. The material of the holding portion 26b may be a resin, a metal or the like; however, it is not particularly limited as long as the material has a predetermined strength.

The sub-air chamber member 10 is attached to the rim 11 of this vehicle wheel 1 by screwing the bolt 24a inserted through the insertion hole 24b of the fastening portion 23a into the holding portion 26b of the air valve assembly 26.

According to the structure of this vehicle wheel 1, it is possible to fasten the sub-air chamber member 10 to the rim 11 by integrating the brackets 23 serving as support members with the sub-air chamber member 10.

According to this vehicle wheel 1, it is possible to attach the sub-air chamber member 10 to the rim 11 in an attachable and detachable manner.

According to the structure of the vehicle wheel 1 shown in FIG. 5, the brackets 23 partially embedded in the main body portion 13 by insert molding are fastened to the air valve assembly 26. However, according to the present invention, the brackets 23 and the air valve assembly 26 may be integrated in advance and then the brackets 23 may be partially embedded in the main body portion 13 by insert-molding.

With this vehicle wheel 1, it is possible to streamline the production process of the vehicle wheel 1 by reducing the number of parts and the assembling cost.

Although illustration is omitted, a sub-air chamber member 10 integrated with the metal support members may be joined to the rim 11 via the support members by welding the supporting members to the rim 11. Needless to say, such a sub-air chamber member 10 can be joined to the rim 11 by fitting like conventional vehicle wheels.

According to the embodiments of the present invention described above, the sub-air chamber member 10 made of a synthetic resin provides various modes of attachment to the rim 11 of the vehicle wheel 1.

What is claimed is:

1. A vehicle wheel, comprising:
a wheel having a rim;
a sub-air chamber member serving as a Helmholtz resonator, the sub-air chamber member being made of a synthetic resin; and
a support member integrated with the sub-air chamber member and joined to the rim, the support member being made of a metal.

2. The vehicle wheel according to claim 1, wherein
the support member is insert molded in the sub-air chamber member.
